(19) United States
(12) Patent Application Publication
(10) Pub. No.: US 2015/0205522 A1
(43) Pub. Date: Jul. 23, 2015

(54) ELECTRONIC APPARATUS CONTROLLING METHOD

(71) Applicant: MediaTek Singapore Pte. Ltd., Singapore (SG)

(72) Inventor: Sai Zeng, Gulin County (CN)

(21) Appl. No.: 14/469,579

(22) Filed: Aug. 27, 2014

(30) Foreign Application Priority Data
Jan. 20, 2014 (CN) 201410024195.3

(51) Int. Cl. G06F 3/0488; G06F 3/0484; G06F 3/0481

(52) U.S. Cl. CPC G06F 3/04886; G06F 3/04817; G06F 3/04847; G06F 3/04845

(57) ABSTRACT

An electronic apparatus controlling method applied to an electronic apparatus comprising a touch control display. The electronic apparatus controlling method comprises: (a) displaying a mapping cursor activating icon on the touch control display; (b) triggering the mapping cursor activating icon to generating a mapping cursor on the touch control display and defining an operation mapping region on the touch control display, wherein the mapping cursor moves corresponding to movement of the mapping cursor activating icon; and (c) controlling a mapping cursor region corresponding to the mapping cursor to generate a mapping control operation if an initial control operation is performed on the operation mapping region.

### CROSS REFERENCE TO RELATED APPLICATIONS

This Application claims priority of China Patent Application No. 201410024195.3, filed on Jan. 20, 2014, the entirety of which is incorporated by reference herein.

### BACKGROUND

The present invention relates to an electronic apparatus controlling method, and particularly relates to an electronic apparatus controlling method which allows single hand control.

There is a tendency to provide a larger touch control display to a smart phone since the manufacturer hopes the user can have better visual experience. A larger touch control may provide better visual experience, but is inconvenient for a user to control it by single hand. FIG. 1 is a schematic diagram illustrating how to control a mobile phone by single hand for prior art. As depicted in FIG. 1, the mobile phone M comprises a touch control display TS, and the controllable region SR thereon indicates a region that the fingers of the hand H can control if the user holds the mobile phone M via the hand H. Based on FIG. 1, the controllable region SR only occupies a small part of the touch control display TS. Accordingly, most part of the touch control display TS cannot be controlled by single hand.

Many techniques are developed to solve this problem. For example, display a simple control interface on the controllable region SR, such that the user can control the mobile phone M via the simple control interface. Alternatively, display a down scaled full screen on the controllable region SR, such that the user can directly perform a control command to the down scaled full screen. Furthermore, another related technique provides a single hand grip, such that the user can use the single hand grip to hold the mobile phone M and control the mobile phone safely.

However, above-mentioned techniques all have disadvantages. For example, the simple control interface can only provide few functions such as: return, home, but cannot provide a complicated function. Also, the down scaled full screen blocks the original main screen, and the user can only see the down scaled full screen to control the mobile phone, which is not conductive to precise control. Thereby the advantage for the touch control display of a large size is reduced. Furthermore, the extra single hand grip not only decreases aesthetic feeling, but also increases the burden for the user to bring it.

### SUMMARY

Accordingly, one objective of the present application is to provide an electronic apparatus controlling method, such that the user can easily perform various kinds of operations by a single hand.

One embodiment of the present application discloses an electronic apparatus controlling method applied to an electronic apparatus comprising a touch control display. The electronic apparatus controlling method comprises: (a) displaying a mapping cursor activating icon on the touch control display; (b) triggering the mapping cursor activating icon to generating a mapping cursor on the touch control display and defining an operation mapping region on the touch control display, wherein the mapping cursor moves corresponding to movement of the mapping cursor activating icon; and (c) controlling a mapping cursor region corresponding to the mapping cursor to generate a mapping control operation if an initial control operation is performed on the operation mapping region.

Based on above-mentioned embodiments, the user can easily perform single hand control. Also, the control operations can be combined for different application, thus the electronic apparatus controlling methods according to the present application has wise application ranges.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating how to control a mobile phone by single hand for prior art.

FIG. 2 to FIG. 9 are schematic diagrams illustrating electronic apparatus controlling methods according to different embodiments of the present application.

FIG. 10 to FIG. 19 are schematic diagrams illustrating the situation that electronic apparatus controlling methods according to embodiments of the present application are applied to dial a phone call.

FIG. 20 to FIG. 24 are schematic diagrams illustrating the situation that electronic apparatus controlling methods according to embodiments of the present application are applied to zoom in and zoom out a map.

FIG. 25 to FIG. 31 are schematic diagrams illustrating the situation that electronic apparatus controlling methods according to embodiments of the present application are applied to a social network software interface.

FIG. 32 is a schematic diagram illustrating the situation that electronic apparatus controlling methods according to embodiments of the present application are applied to a website browsing.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

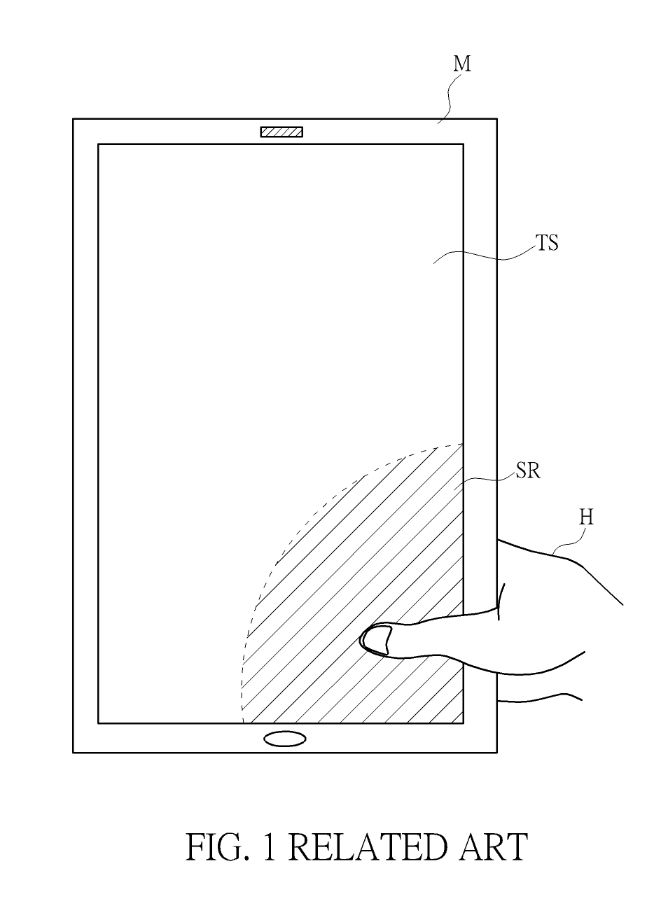

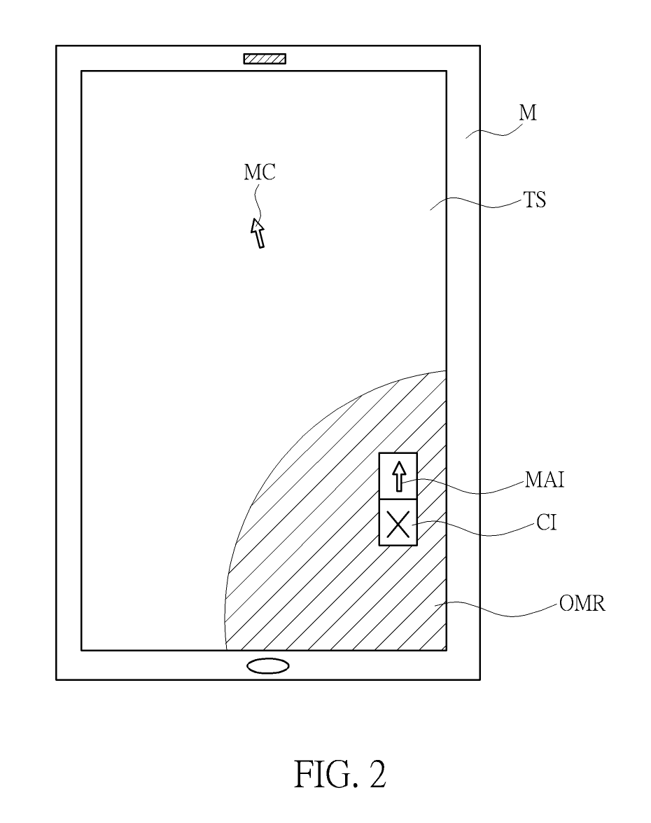

FIG. 2 to FIG. 9 are schematic diagrams illustrating electronic apparatus controlling methods according to different embodiments of the present application. Please note persons skilled in the art can combine any of the embodiments depicted in FIG. 2 to FIG. 9, to generate a new embodiment. Such kind of variation should also fall in the scope of the present application. Also, a mobile phone M is taken for example to explain the embodiments of the present application, but it does not mean the electronic apparatus controlling methods according to the present application can only be applied to the mobile phone. The methods according to the present application can be applied to other electronic apparatuses as well, for example, an electronic apparatus with a touch control display such as a PDA or a tablet PC. As shown in FIG. 2, the mobile phone M comprises a touch control display TS, which displays a mapping cursor activating icon MAI and defines an operation mapping region if a single hand mode is triggered (ex. triggered by a gesture or a switch). A mapping cursor MC is displayed if the mapping cursor activating icon MAI is triggered (ex. being tapped). In one embodiment, the operation mapping region OMR corresponds to a range that fingers of a single hand can touch when the user holds the mobile phone M with the single hand (ex. SR in FIG. 1). Additionally, the operation mapping region OMR can be displayed (ex. via a curve, a half-transparent region or a region with a specific color) or not displayed on the mobile phone M. In one embodiment, the mobile phone further displays an operation mapping region cancelling icon CI, wherein the operation mapping region OMR (i.e. the single hand mode is cancelled) is cancelled and backs to the initial mode if the operation mapping region cancelling icon CI is triggered. The operation mapping region cancelling icon CI can be integrated to the mapping cursor activating icon MAI. For example, the operation mapping region OMR can be cancelled via double tapping or pressing and holding the mapping cursor activating icon MAI.

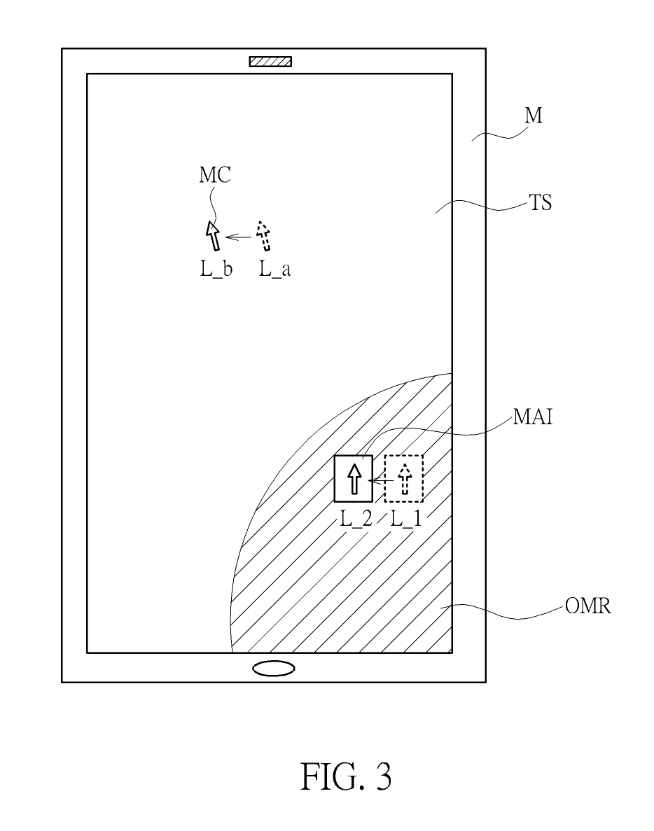

The mapping cursor MC can be moved via moving the mapping cursor activating icon MAI. As shown in FIG. 3, the mapping cursor MC correspondingly moves from the location L_a to the location L_b if the mapping cursor activating icon MAI moves from the location L_1 to the location L_2. In one embodiment, if the user presses and holds the mapping cursor activating icon MAI to move it from the location L_1 to the location L_2 and releases it to actives the mapping cursor activating icon MAI, it goes back to the location L_1.

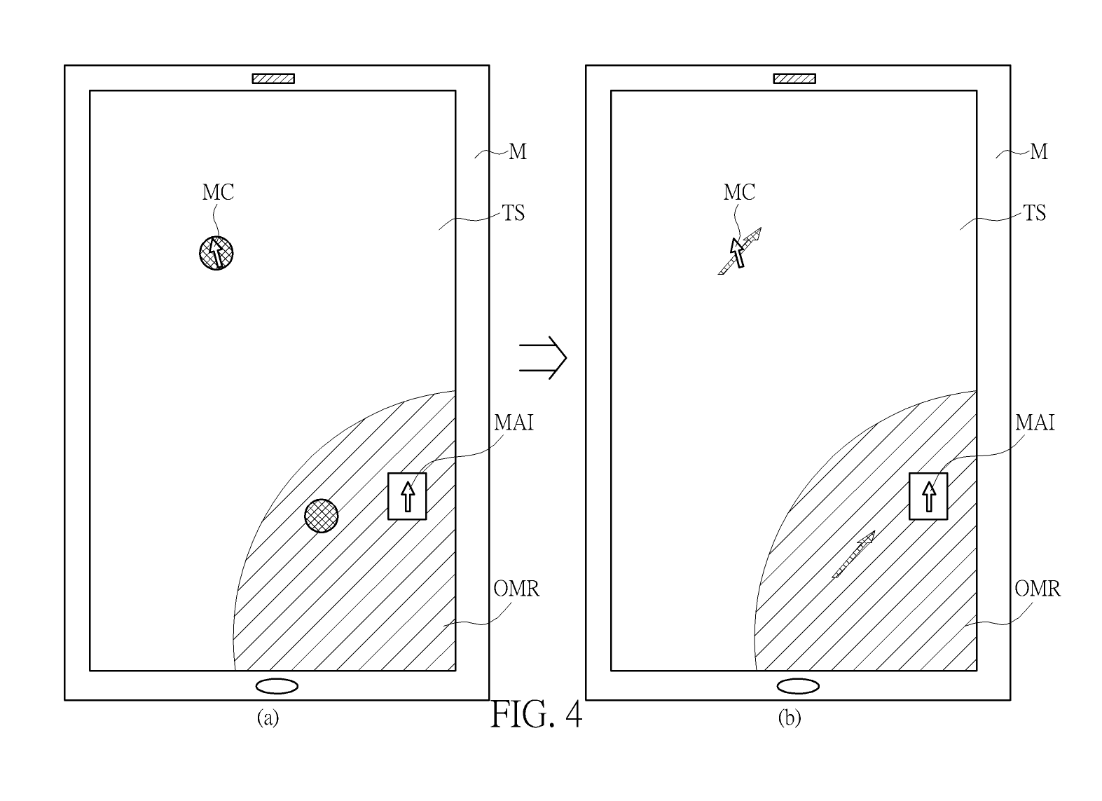

After moving the mapping cursor MC to a desired location via above-mentioned steps, a mapping cursor region corresponding to the mapping cursor MC (ex. a region that comprises the mapping cursor MC as a center) generates a mapping control operation if an initial control operation is performed on the operation mapping region OMR. Take FIG. (a) in FIG. 4 as an example, if a tapping operation (i.e. the initial control operation) is performed in the operation mapping region OMR, a tapping operation (i.e. the mapping control operation) is correspondingly generated at a mapping cursor region corresponding to the mapping cursor MC. Furthermore, as show in FIG. (b) of FIG. 4, if a sliding operation (i.e. the initial control operation) is performed in the operation mapping region OMR, a sliding operation (i.e. the mapping control operation) is correspondingly generated at a mapping cursor region corresponding to the mapping cursor MC.

In one embodiment, the operation mapping region OMR is cancelled after one initial control operation is performed in the operation mapping region and a mapping control operation is generated at a mapping cursor region corresponding to the mapping cursor MC.

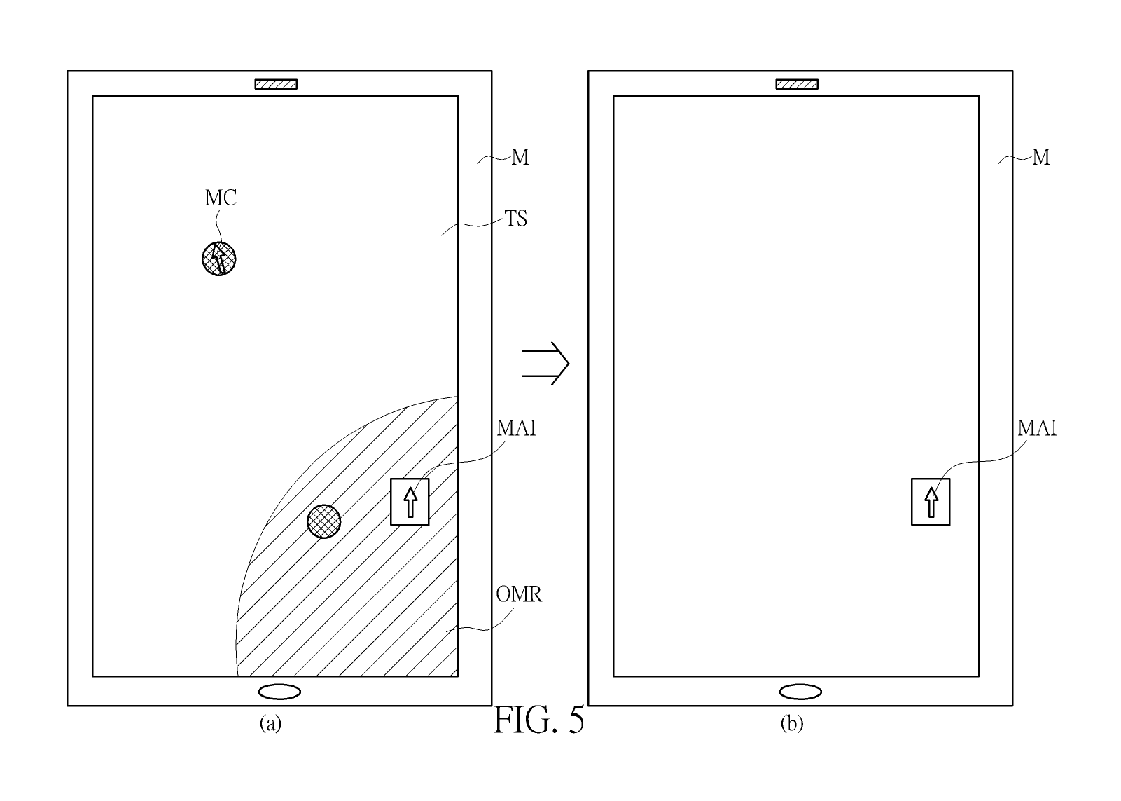

As shown in FIG. (a) in FIG. 5, if a tapping operation is performed in the operation mapping region OMR, a tapping operation is correspondingly generated at a mapping cursor region corresponding to the mapping cursor MC. After that, the operation mapping region OMR is cancelled, as shown in FIG. 5(b). After the operation mapping region OMR is cancelled, the mapping cursor MC can be sustained or be cancelled.

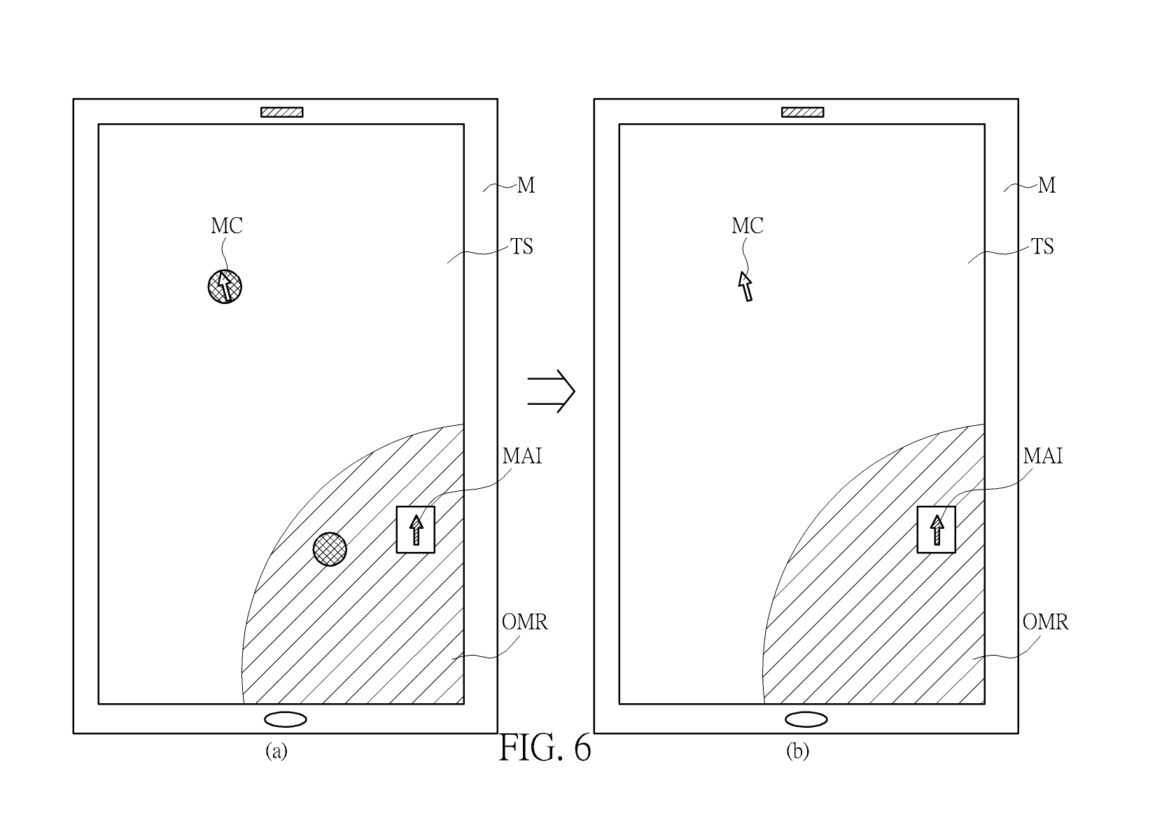

In another embodiment, a sustaining operation mapping region mode can be activated. The operation mapping region OMR is not cancelled even if at least the initial control operation is performed in the operation mapping region and at least one mapping control operation is generated at a mapping cursor region corresponding to the mapping cursor MC in the sustaining operation mapping region mode. As shown in FIG. (a) of FIG. 6, if double tapping, pressing and holding the mapping cursor activating icon MAI, the sustaining operation mapping region mode can be activated. In one example, the mapping cursor activating icon MAI is displayed in a specific manner in the sustaining operation mapping region mode, for example, with oblique lines. In such situation, the operation mapping region OMR is not cancelled even if at least one tapping operation is performed in the operation mapping region and at least one tapping operation is generated at a mapping cursor region corresponding to the mapping cursor MC. The sustaining operation mapping region mode is not limited to be activated by the mapping cursor activating icon MAI, but also can be activated by an extra icon (not illustrated here).

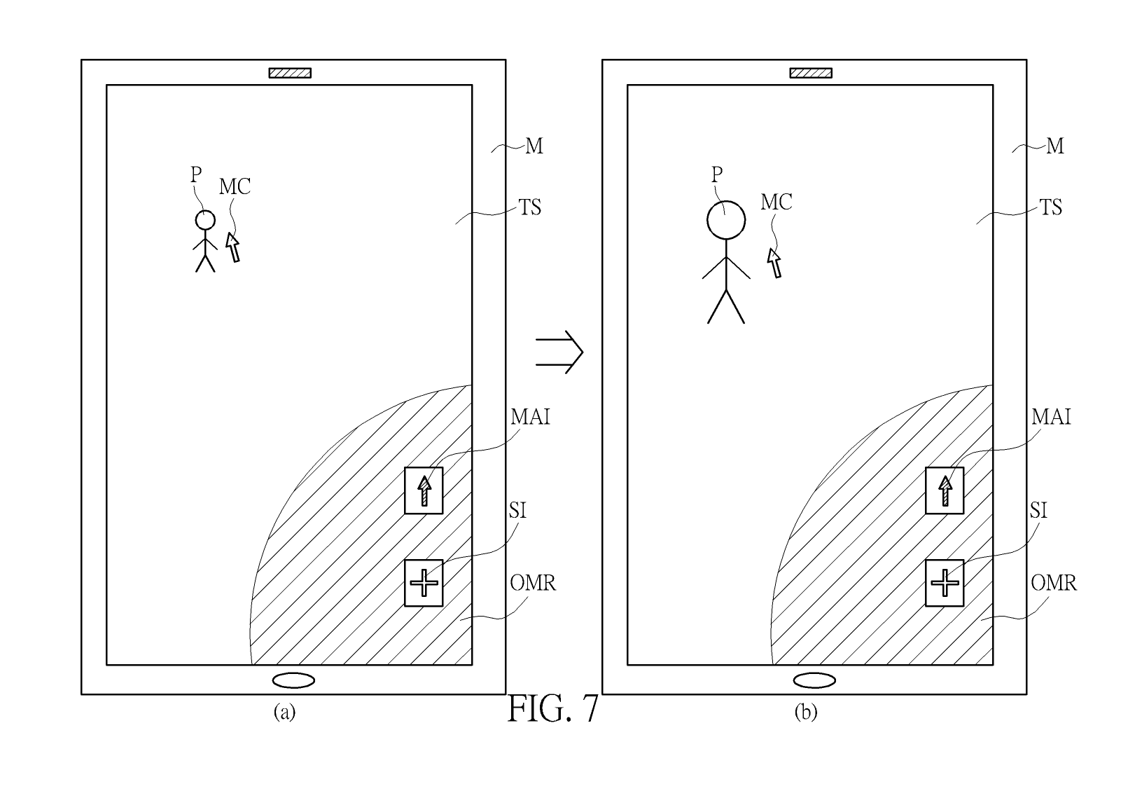

In one embodiment, an extra function icon is displayed on the touch control display. If the extra function icon is triggered, performing a predetermined control operation or a mapping control operation corresponding to the extra function icon in the mapping cursor region corresponding to the mapping cursor. As shown in FIG. (a) of FIG. 7, a zoom icon SI is displayed on the touch control display TS. A zoom operation is performed for the image in the mapping cursor region corresponding to the mapping cursor MC if the extra function icon is triggered (ex. tapping or moving). For example, the people image P in FIG. (a) of FIG. 7 is zoomed in in FIG. (b) if the zoom icon SI is triggered. Persons skilled in the art can understand, in other embodiments some predetermined control operations such as returning or displaying home page can be performed if such extra function icon is triggered.

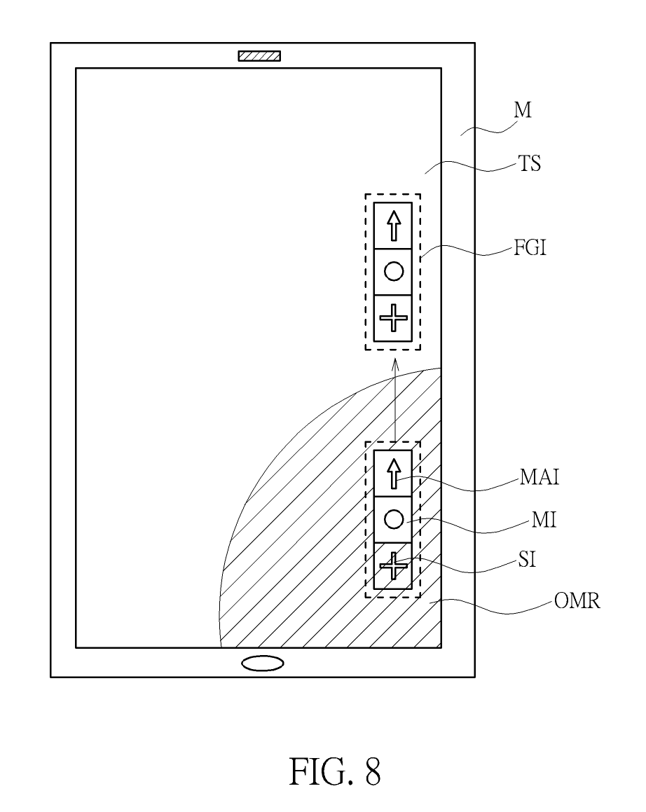

In one embodiment, a function group icon is displayed on the touch control display. The function group icon comprises the mapping cursor activating icon and a moving icon. The function group icon is correspondingly moved while moving the moving icon. As shown in FIG. 8, the touch control display TS displays a function group icon FGI. In this example, the function group icon FGI comprises above-mentioned cursor activating icon MAI and the zoom icon SI (optional). Additionally, the function group icon FGI further comprises a moving icon MI. The user can move the moving icon MI to move the function group icon FGI to another location.

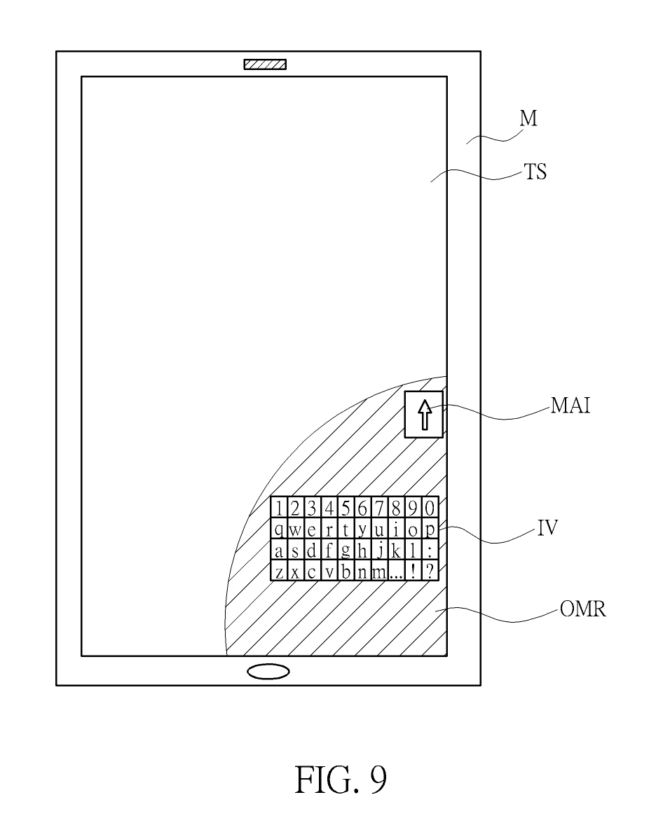

In one embodiment, if an input interface is displayed, all buttons for an input interface are displayed in the operation mapping region OMR in a scaling down manner. As depicted in FIG. 9, an input interface IV (ex. a keyboard) is displayed, all buttons for the input interface IV are displayed in a region corresponding to the operation mapping region OMR in a scaling down manner. By this way, the user can input the command via inputting a command to the input interface IV by the single hand. In another embodiment, the mapping cursor activating icon MAI does not overlap the input interface IV while displaying both of the input interface IV and the mapping cursor activating icon MAI, as shown in FIG. 9.

The following embodiments depict how above-mentioned steps are applied to different functions. Please note the scope of the present application is not limited to following functions or combinations thereof. For the clarity of understanding, the operation mapping region OMR in following embodiments are indicated by a curve line rather than marked by oblique lines. If the curve line is a solid line, it means the operation mapping region OMR is activated. On the contrary, if the curve line is a dotted line, it means the operation mapping region OMR is cancelled, thus the dotted line only indicates a range that fingers of a single hand can touch (ex. SR in FIG. 1). Please note either the solid line or the dotted line are not necessary to be displayed on the touch control display.

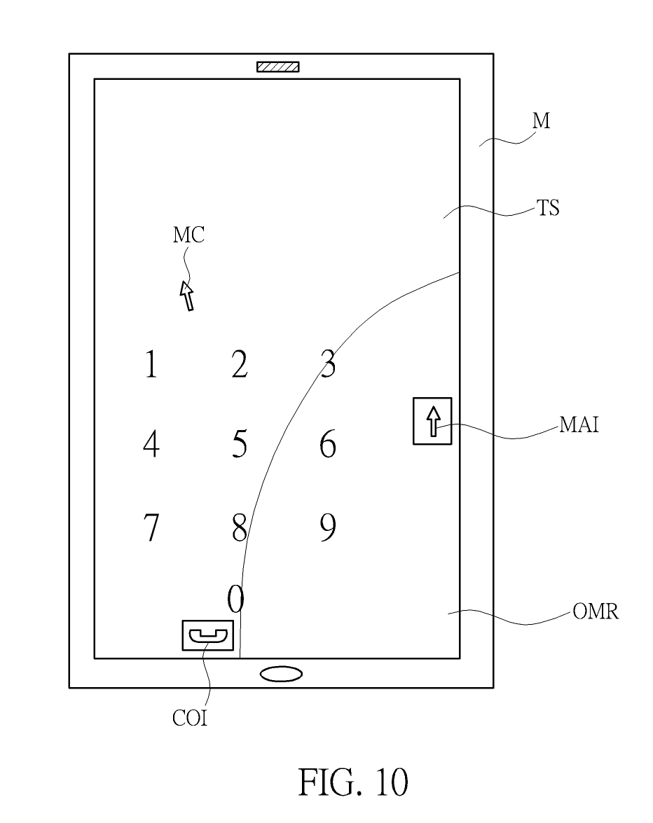

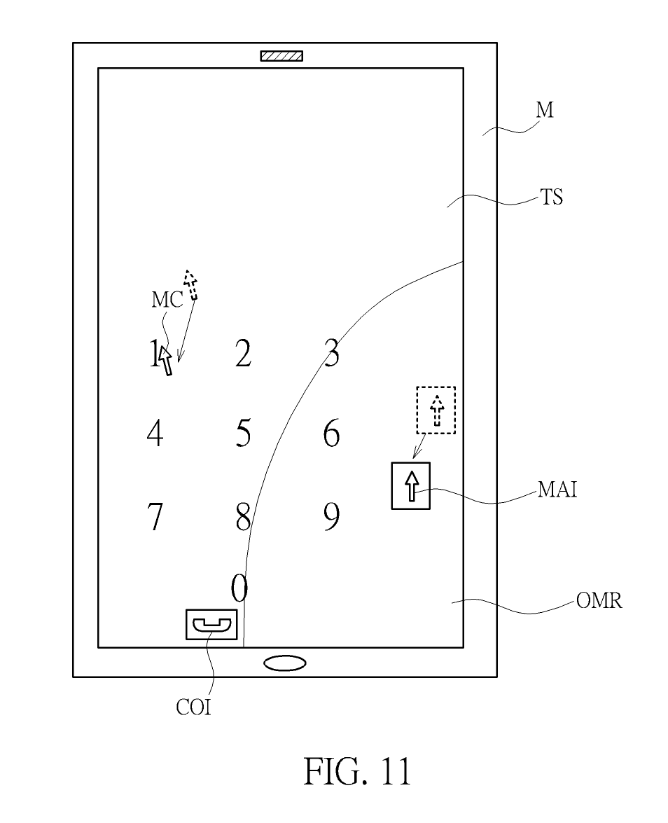

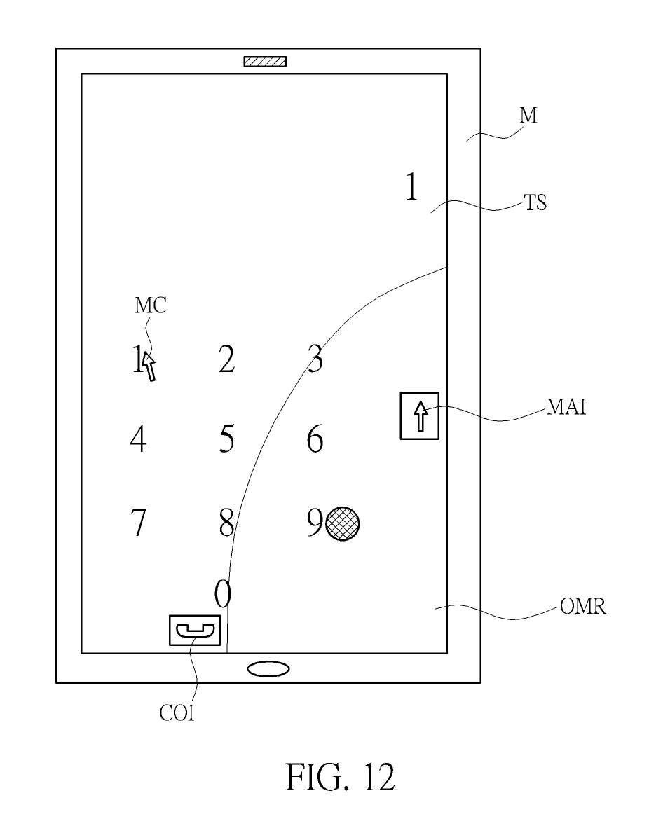

FIG. 10 to FIG. 19 are schematic diagrams illustrating the situation that electronic apparatus controlling methods according to embodiments of the present application are applied to dial a phone call. As shown in FIG. 10, the single hand mode is activated if enters a phone dialing interface. The mapping cursor MC is displayed and an operation mapping region OMR is defined after triggering the mapping cursor activating icon MAI. In FIG. 11, the mapping cursor MC is moved to a numeral 1 via moving the mapping cursor activating icon MAI. In FIG. 12, a tapping operation (i.e. the above-mentioned initial control operation) is performed in the operation mapping region OMR such that a tapping operation (i.e. the above-mentioned mapping control operation)is generated in the mapping cursor region corresponding to the mapping cursor MC. In such case, a dialing numeral 1 is generated since the mapping cursor MC is located at the numeral 1.

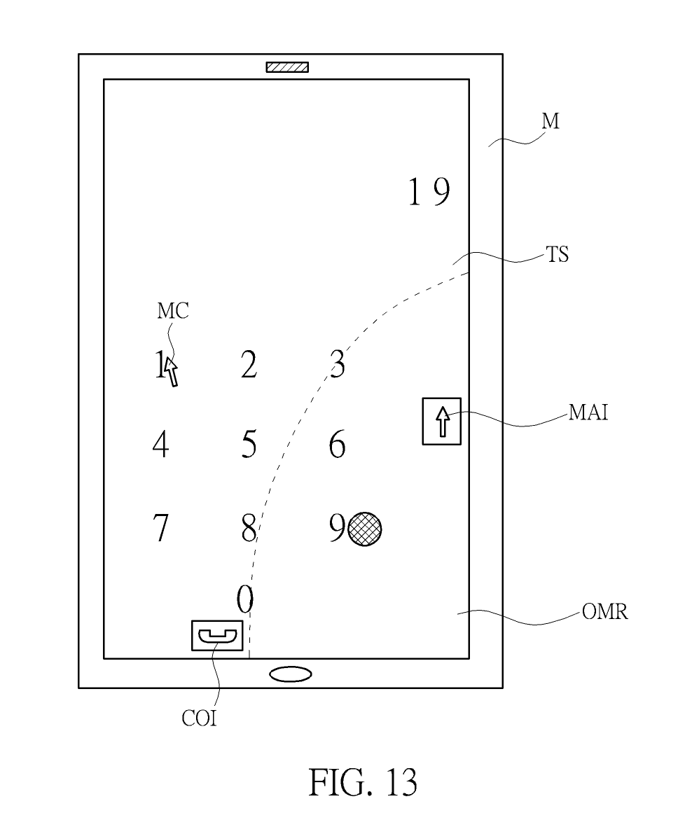

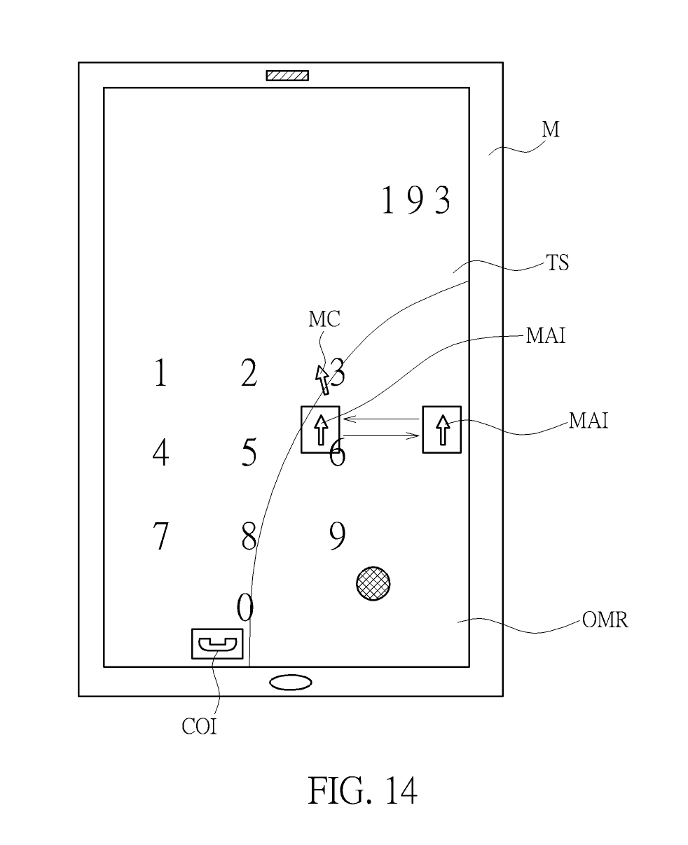

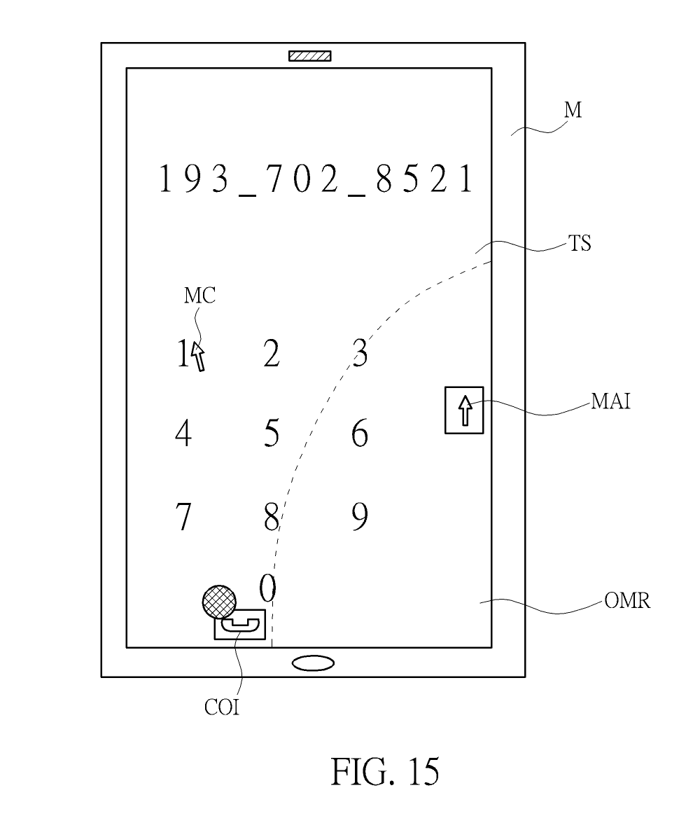

In this embodiment, the operation mapping region OMR is cancelled after a tapping operation is performed in the operation mapping region OMR and a tapping operation is correspondingly generated in the mapping cursor region corresponding to the mapping cursor MC. In FIG. 13, although the numeral 9 locates in the region which was covered by the operation mapping region OMR, the user can still tap the numeral 9 to generate the dialing numeral 9 since the operation mapping region OMR is cancelled after the operation in FIG. 12. In FIG. 14, the dialing numeral 3 is desired to be generated. The dialing numeral 3 can be generated via directly tap or via above-mentioned method of generating the mapping cursor MC, since part of the numeral 3 locates inside the range corresponding to the operation mapping region OMR and the other part locates outside the range corresponding to the operation mapping region OMR. In FIG. 14, the numeral 3 is generated via above-mentioned method of generating the mapping cursor MC. Accordingly, the mapping cursor activating icon MAI is triggered to generate the mapping cursor MC and the operation mapping region OMR, then the mapping cursor is moved to the location of the numeral 3, and then the operation mapping region OMR is tapped to generate the dialing numeral 3. In FIG. 15, a dialing number 1937028521 is generated following above-mentioned steps, and then the dialing icon COI is tapped to make a phone call.

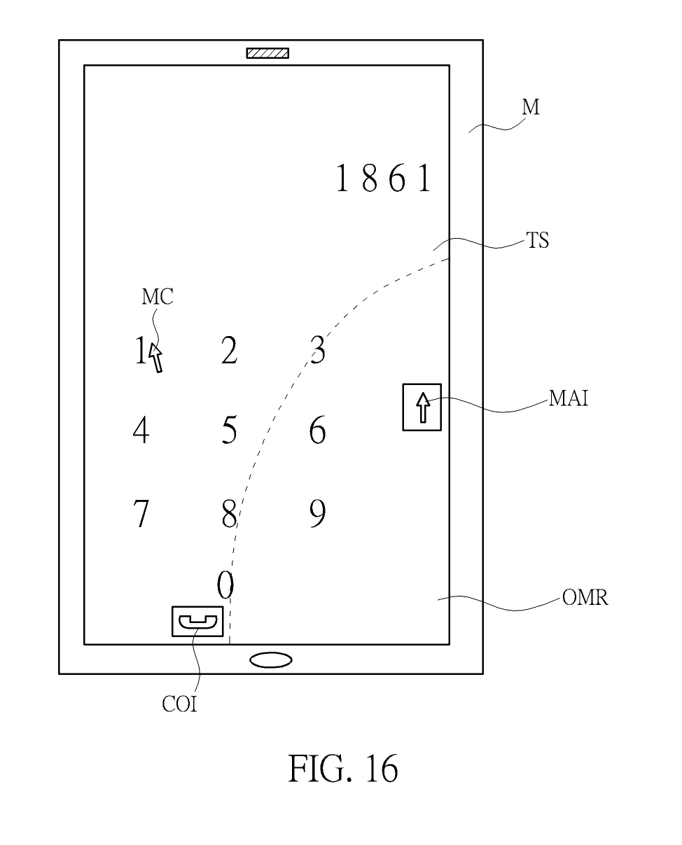

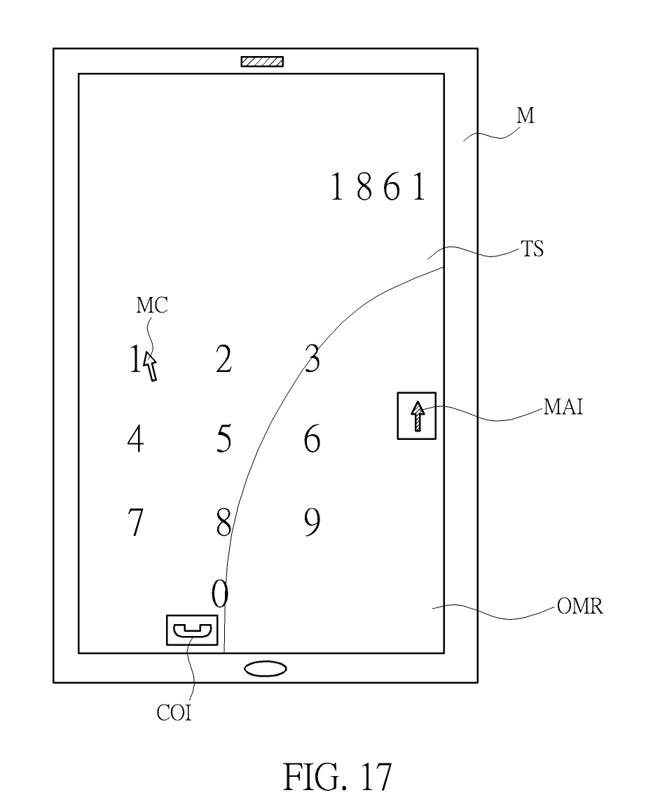

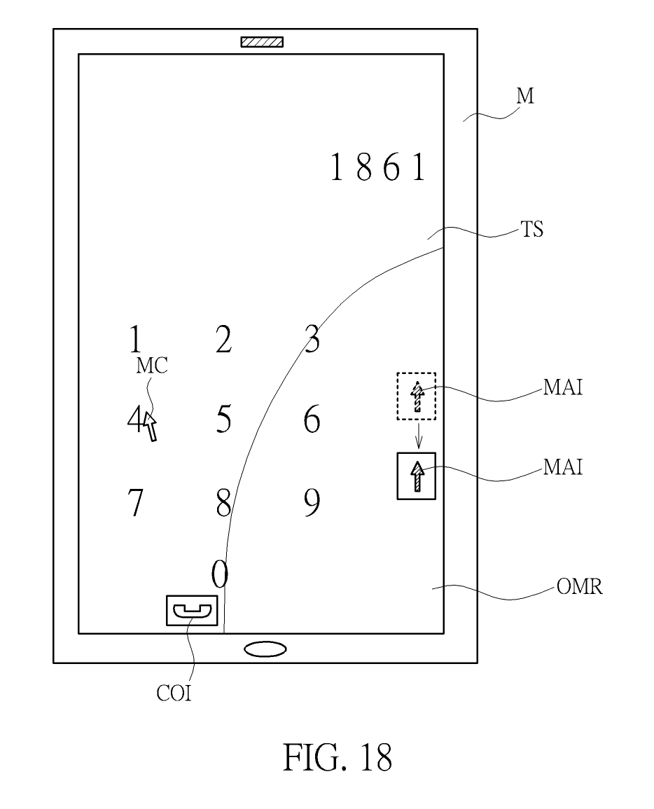

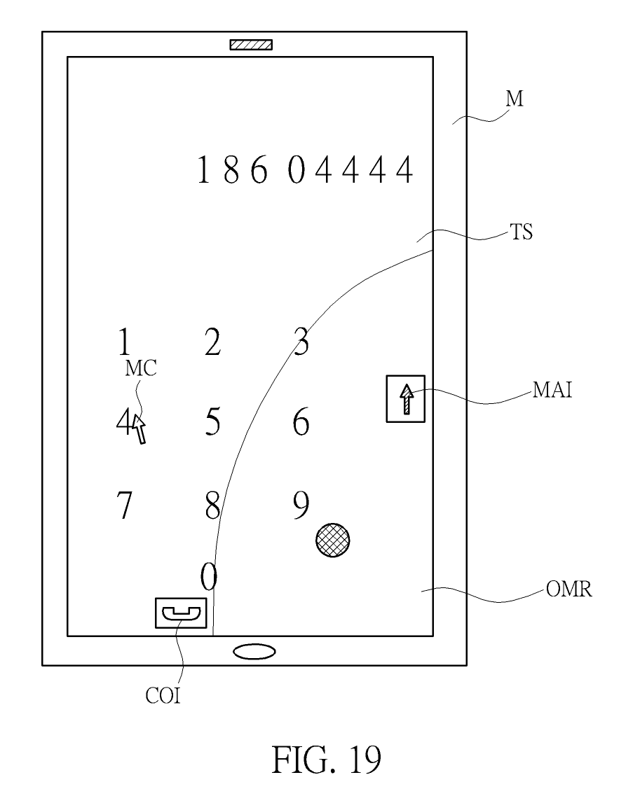

A phone number with continuous numerals may be dialed while making a phone call. In FIG. 16, the dialing number 1861 is generated via above-mentioned steps, in such case the mapping cursor locates at the numeral 1 and the operation mapping region OMR is cancelled. If the desired dialing number is 18614444, the sustaining operation mapping region in FIG. 6 can be applied. In FIG. 17, the sustaining operation mapping region is activated, which is activated by pressing and holding the mapping cursor activating icon MAI in this example, thus the arrow of the mapping cursor activating icon MAI in FIG. 17 becomes from white to be marked by oblique lines in such case. In FIG. 18, the mapping cursor MC is moved to the numeral 4 via moving the mapping cursor activating icon MAI. After that, tap the operation mapping region OMR to generate the dialing number 4444 as shown in FIG. 19.

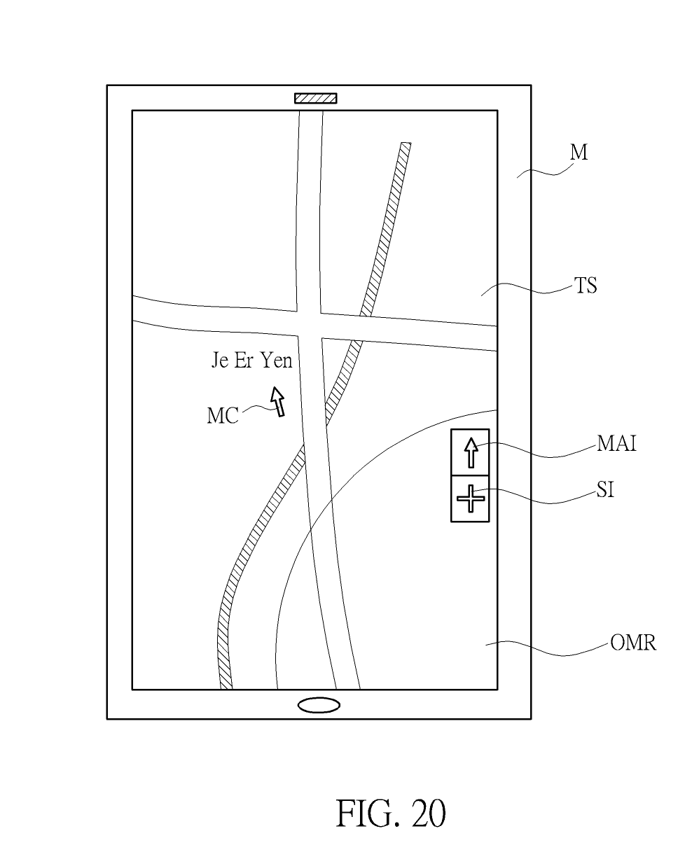

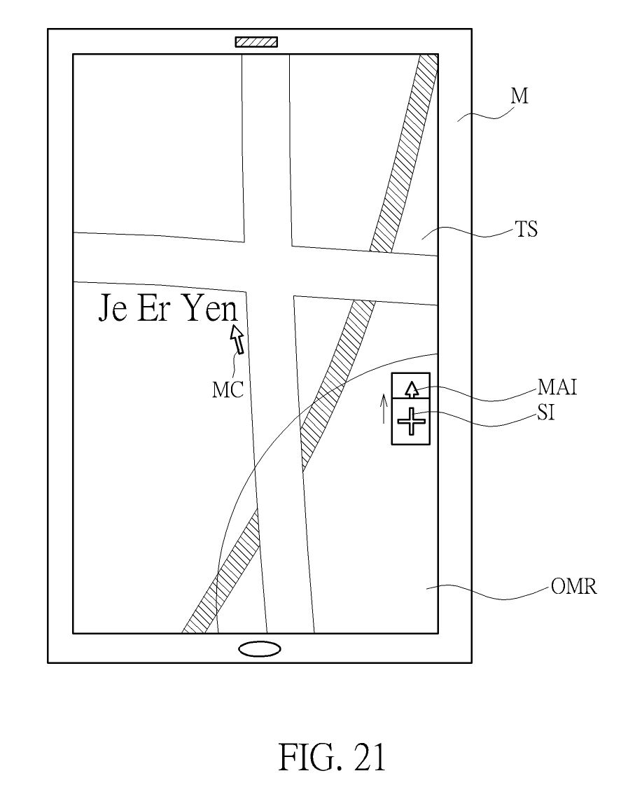

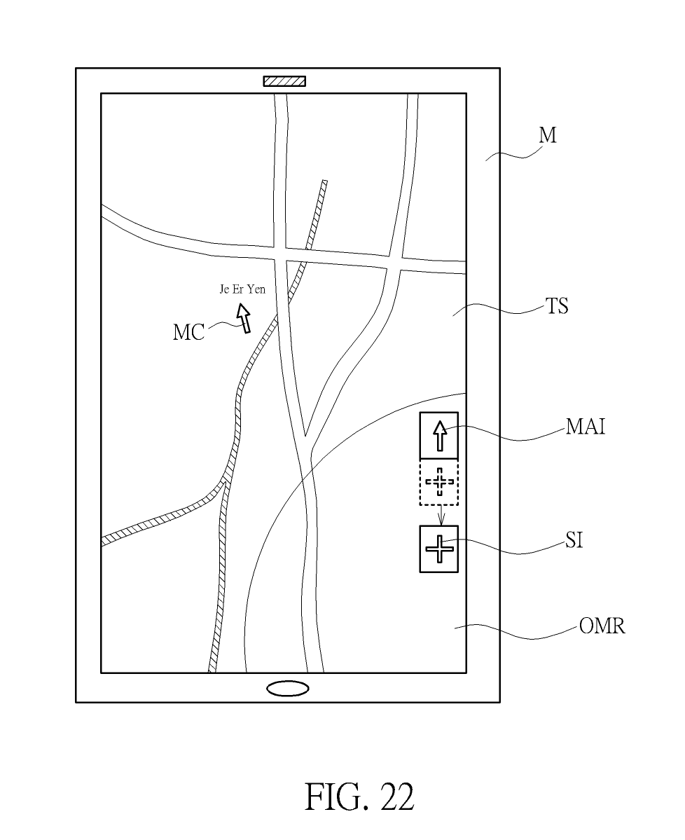

FIG. 20 to FIG. 24 are schematic diagrams illustrating the situation that electronic apparatus controlling methods according to embodiments of the present application are applied to zoom in and zoom out a map. In FIG. 20, the user wants to zoom in the map nearby the location “Je Er Yan” while the map is displayed. The location “Je Er Yan” locates outside the range that can be controlled by a single hand, however. Accordingly, the single hand mode is activated. The mapping cursor activating icon MAI and the zoom icon SI are displayed, and then the mapping cursor MC is moved to “Je Er Yan” via moving the mapping cursor activating icon MAI, as above-mentioned. In FIG. 21, the zoom icon SI is pushed up to zoom in the map nearby “Je Er Yan”. In FIG. 22, the zoom icon SI is pulled down to zoom out the map nearby “Je Er Yan”. Please note the present application is not limited to such steps, other control operations can be applied to perform zoom in/zoom out operations.

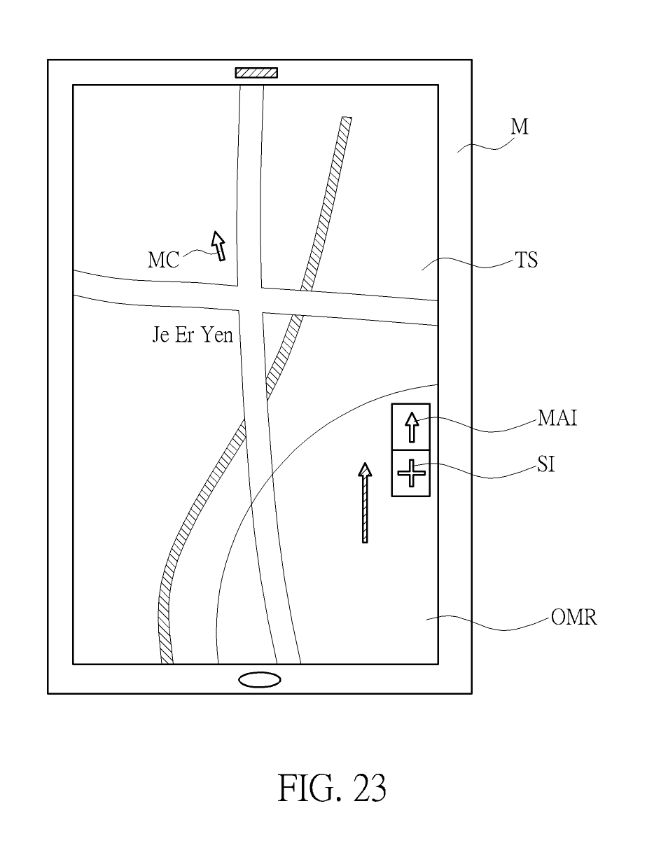

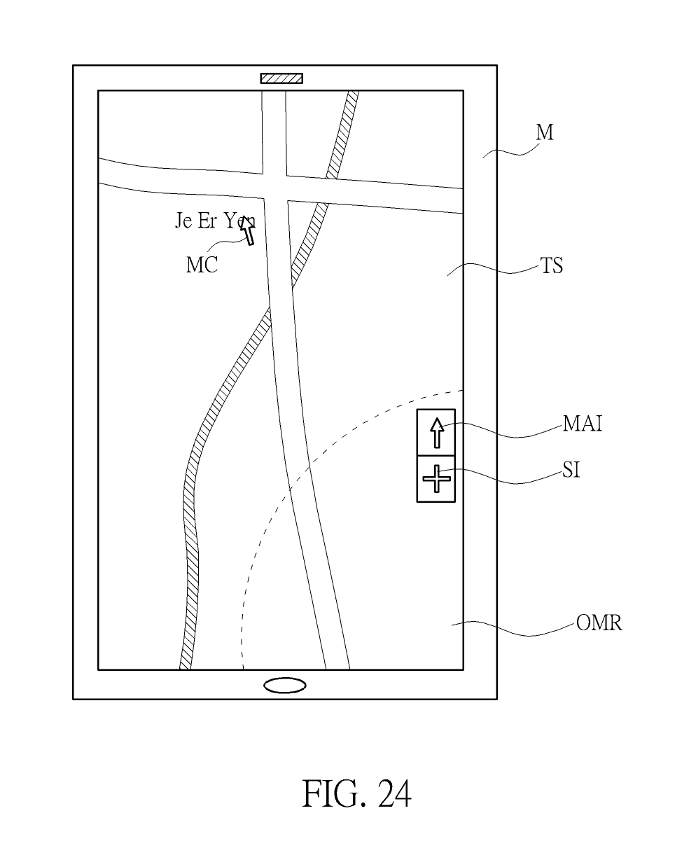

Since the purpose of the embodiments of FIGS. 20 and 21 is to zoom in the map at which the mapping cursor MC locates, the same effect can be reached if moving the map to be zoomed in to the location of the mapping cursor rather than moving the mapping cursor MC. As shown in FIG. 23, the mapping cursor MC is not moved to the location of “Je Er Yan” after the mapping cursor MC is activated. A pulling up operation is performed in the operation mapping region OMR, which causes the mapping cursor region corresponding to the mapping cursor MC to be pulled up, thus the map moves up as show in FIG. 24. The zoom in/zoom out operation shown in FIG. 21 and FIG. 22 can be performed if “Je Er Yan” in the map is moved to the location of the mapping cursor MC.

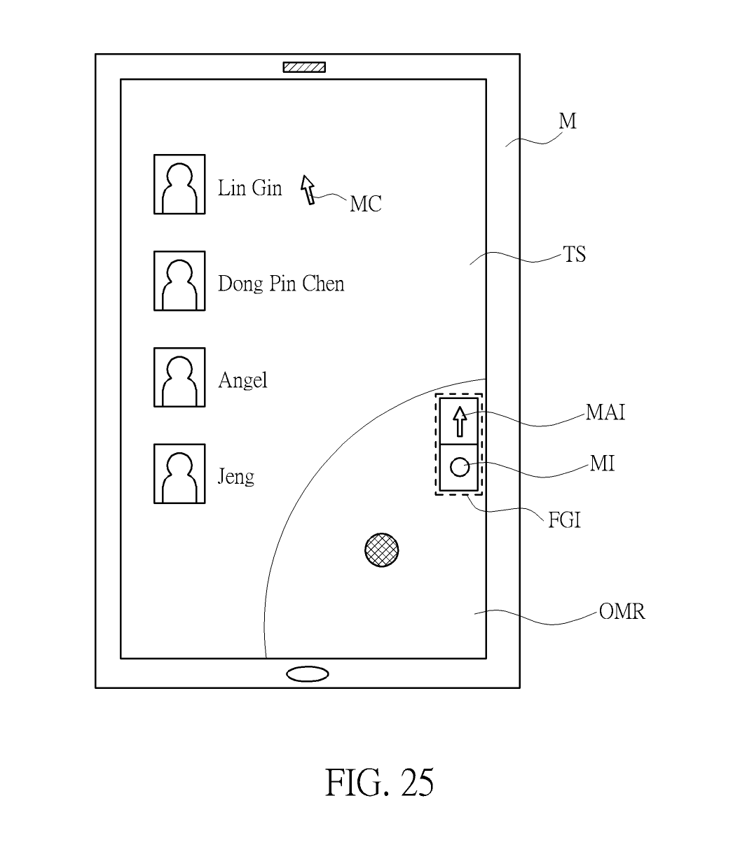

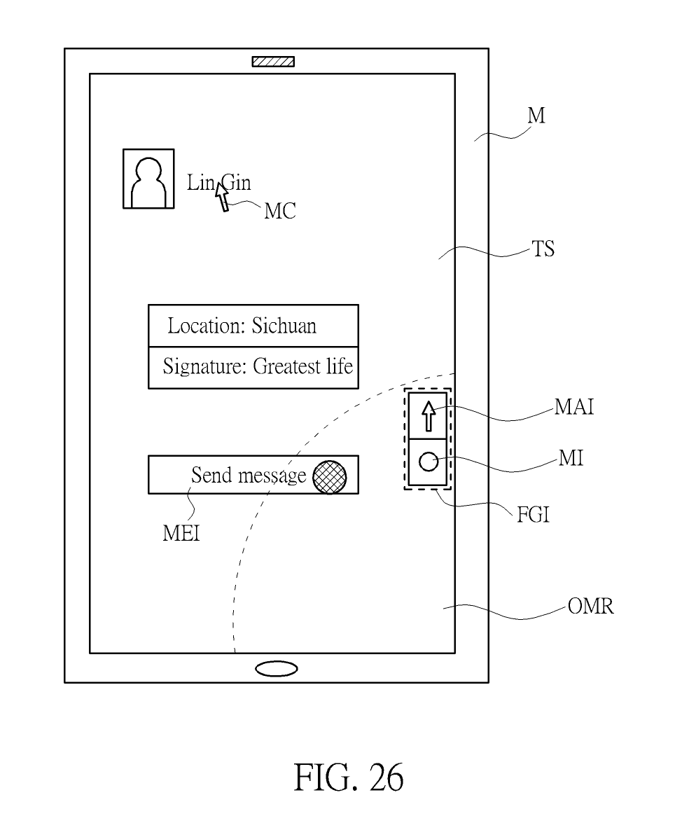

FIG. 25 to FIG. 31 are schematic diagrams illustrating the situation that electronic apparatus controlling methods according to embodiments of the present application are applied to a social network software interface. As shown in FIG. 25, the social network software interface (ex. an interface of Twitter) shows friends of the user. In this embodiment, the user wants to talk with “Lin Gin”, who locates outside a range that can be controlled by a single hand. Therefore, the single hand mode is activated to display the mapping cursor activating icon MAI, and then the mapping cursor MC is moved to the picture or name of “Lin Gin” via moving the mapping cursor activating icon MAI. After that, perform a tapping operation in the operation mapping region OMR, such that a tapping operation is also generated at the location of the mapping cursor MC, to enter the interface shown in FIG. 26. In this embodiment, the mapping cursor activating icon MAI is comprised in the function group icon FGI which further comprises a moving icon MI.

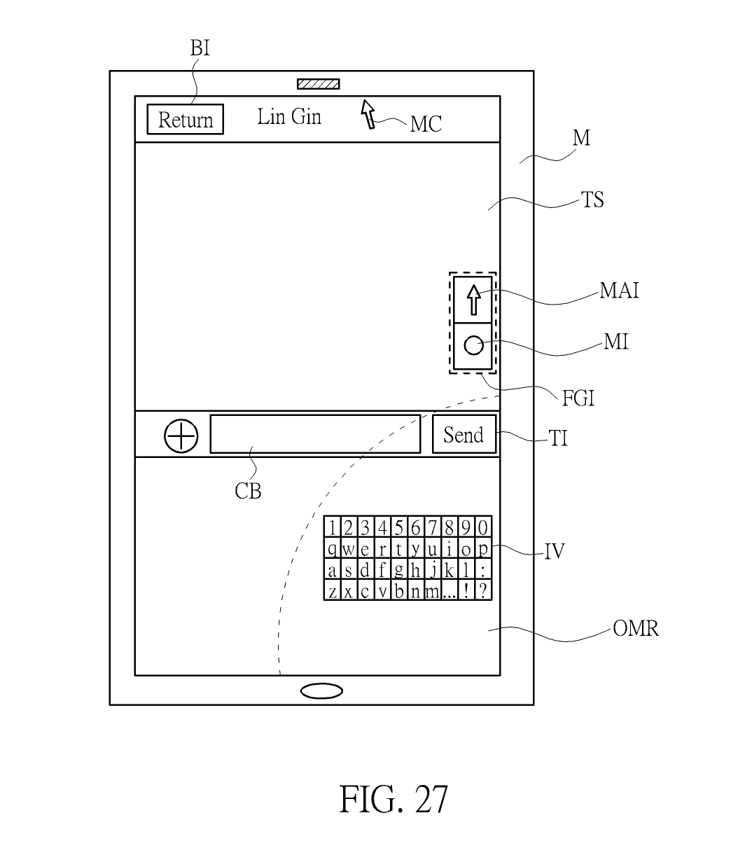

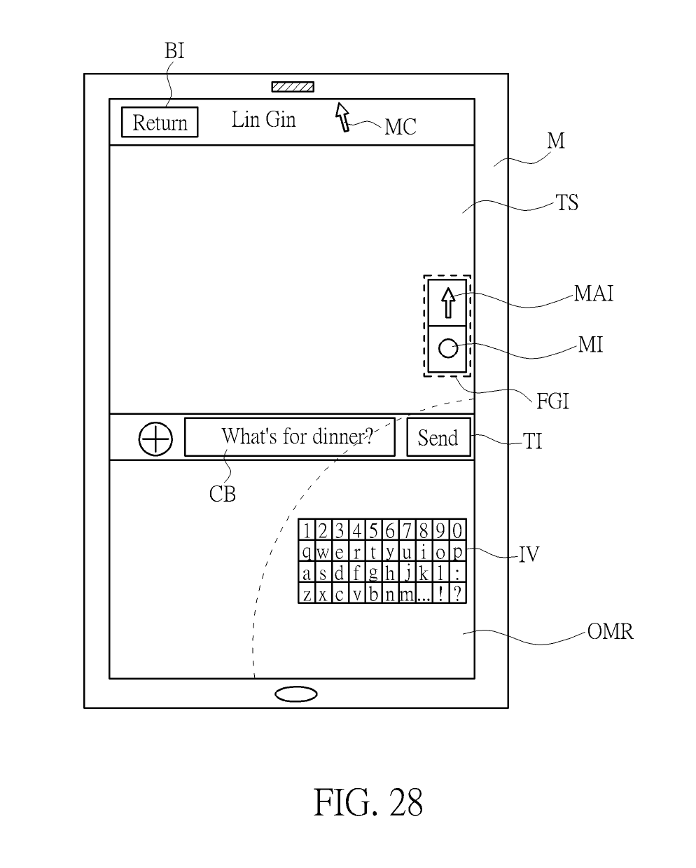

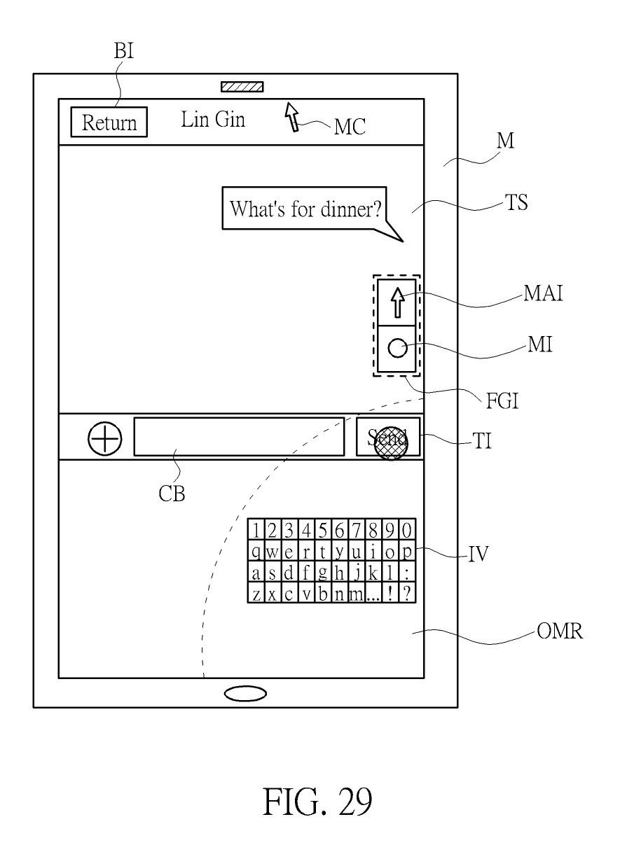

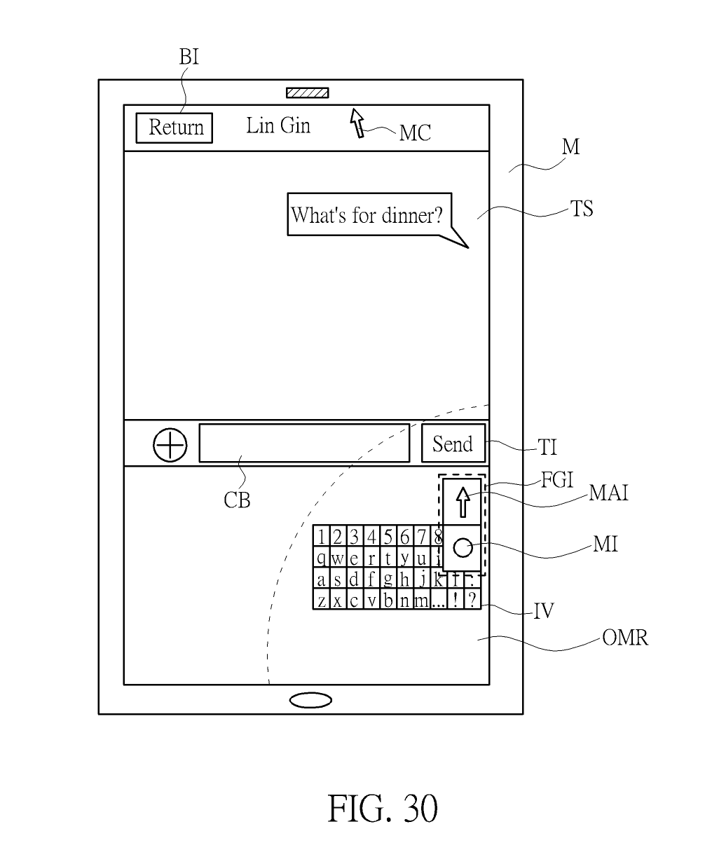

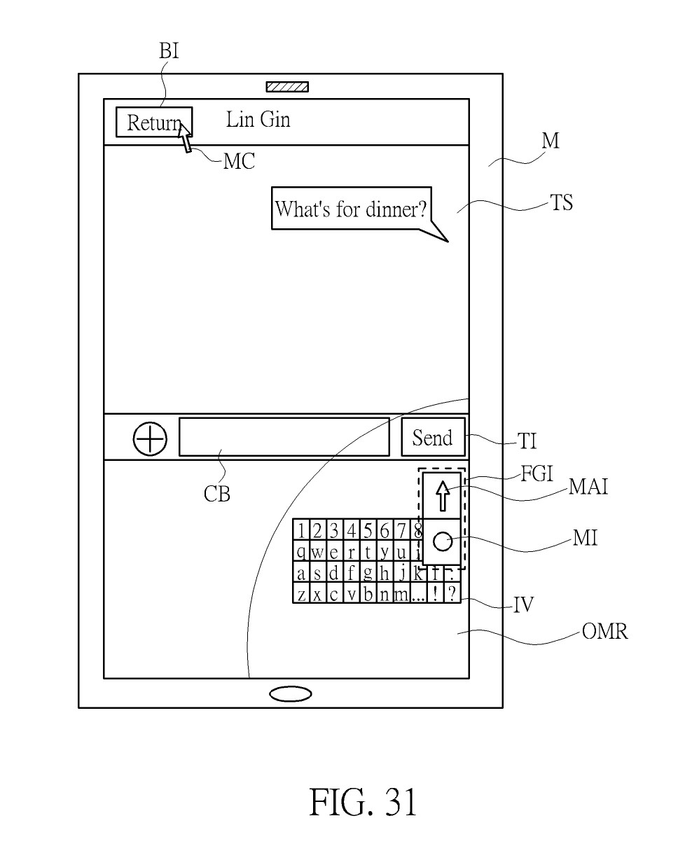

FIG. 26 shows detail information of “Lin Gin” and also shows a message sending icon MEI. The operation mapping region OMR is cancelled since the tapping operation was already performed at the location of the mapping cursor MC (i.e. the mapping control operation) in FIG. 25. Accordingly, the user can directly tap the message sending icon MEI to enter the message sending interface in FIG. 27. In FIG. 27, the function group icon FGI is moved up via the moving icon MI since the function group icon FGI may block the icon necessary for sending the message. In FIG. 28, the user can input the words he wants to send to the talking window CB via a user interface IV generated in the controllable region SR, which can be controlled by a single hand and corresponds to the operation mapping region OMR. Then, tap the sending icon TI to send the message typed in the talking window CB, as shown in FIG. 29. Please note, the operation mapping region OMR is in a cancelling state while using the user interface IV in FIG. 28. In FIG. 30, the function group icon FGI can be moved back to the previous location via the moving icon MI. In FIG. 31, the user wants to leave this screen, but the return button BI locates outside the range that can be controlled by the single hand. Accordingly, the user can activate the single hand mode, to generate the mapping cursor MC, and moves the mapping cursor MC to the location of the return button BI via a movement of the mapping cursor activating icon MAI. After that, a tapping operation is performed in the mapping operation region OMR, such that a tapping operation can be performed to the return button BI, and goes back to the interface shown in FIG. 25. Please note a user interface IV is displayed in the embodiments of FIG. 27 to FIG. 31, and all the buttons for the user interface IV is in a range corresponding to the mapping operation region OMR, such that the user can control more conveniently. However, it is not limited that all the buttons for the user interface IV must be in a range corresponding to the mapping operation region OMR. In another embodiment, only part of the user interface IV can locate in the range corresponding to the mapping operation region OMR. In such case, the corresponding input operation can be performed via above-mentioned methods for generating a mapping cursor MC.

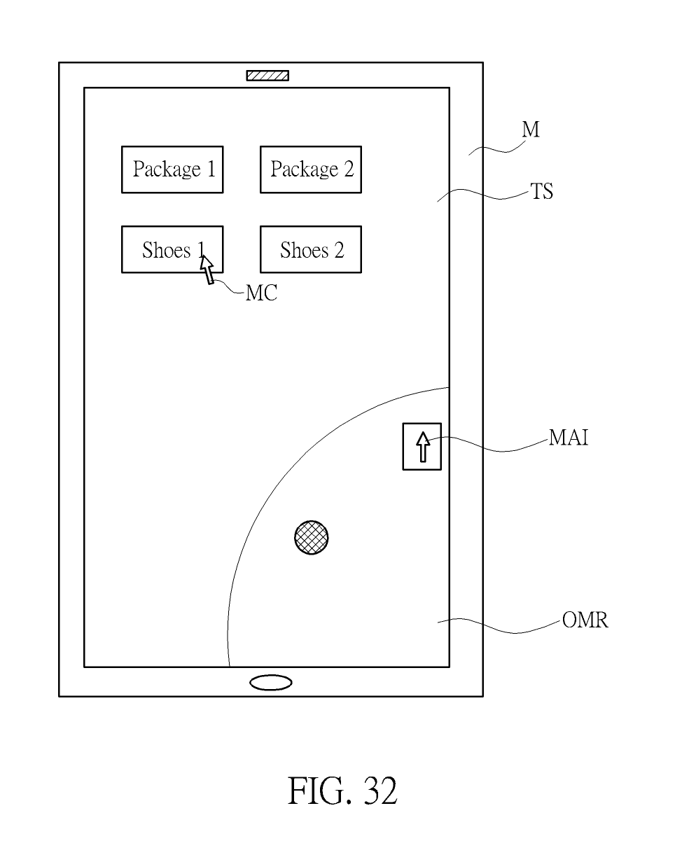

FIG. 32 is a schematic diagram illustrating the situation that electronic apparatus controlling methods according to embodiments of the present application are applied to a website browsing. In this embodiment, the user is browsing a shopping website, and desires to see detail information for a stuff (ex. the shoes 1). However, the stuff icon locates outside the range that can be controlled by the single hand. Accordingly, the user can activate the single hand mode, to generate the mapping cursor MC, and moves the mapping cursor to the location of the shoes 1 icon via a movement of the mapping cursor activating icon MAI. After that, a tapping operation is performed in the mapping operation region OMR, such that a tapping operation can be performed to the shoes 1 icon. By this way, detail information for shoes 1 is displayed. Please note the tapping operation is taken for example to explain this embodiment, but does not mean to limit the scope of the present application. Other control operations can be mapped to the stuff icon via the above-mentioned methods for generating the mapping icon MC, to show detail information for the stuffs.

In view of above-mentioned embodiments, the operations provided by the present application can be independently applied or combined to different functions. Such kind of variation should also fall in the scope of the present application.

Based on above-mentioned embodiments, the user can easily perform single hand control. Also, the control operations can be combined for different application, thus the electronic apparatus controlling methods according to the present application has wise application ranges.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic apparatus controlling method, applied to an electronic apparatus comprising a touch control display, the electronic apparatus controlling method comprising:
(a) displaying a mapping cursor activating icon on the touch control display;
(b) triggering the mapping cursor activating icon to generating a mapping cursor on the touch control display and defining an operation mapping region on the touch control display, wherein the mapping cursor moves corresponding to movement of the mapping cursor activating icon; and
(c) controlling a mapping cursor region corresponding to the mapping cursor to generate a mapping control operation if an initial control operation is performed on the operation mapping region.

2. The electronic apparatus controlling method of claim 1, wherein the operation mapping region is not displayed on the touch control display.

3. The electronic apparatus controlling method of claim 1, wherein the operation mapping region is displayed on the touch control display.

4. The electronic apparatus controlling method of claim 1, wherein the operation mapping region is cancelled after at least the initial control operation is performed.

5. The electronic apparatus controlling method of claim 1, further comprising:
displaying a sustaining operation mapping region activating icon on the touch control display, wherein the operation mapping region is not cancelled even if at least the initial control operation is performed if the sustaining operation mapping region activating icon is triggered.

6. The electronic apparatus controlling method of claim 5, wherein the sustaining operation mapping region activating icon is integrated to the mapping cursor activating icon.

7. The electronic apparatus controlling method of claim 1, further comprising:
displaying an extra function icon on the touch control display;
performing a predetermined control operation or generating the mapping control operation corresponding to the extra function icon in the mapping cursor region corresponding to the mapping cursor, if the extra function icon is triggered.

8. The electronic apparatus controlling method of claim 7, wherein the extra function icon is a zoom icon, wherein a zoom operation is performed in the mapping cursor region corresponding to the mapping cursor if the extra function icon is triggered.

9. The electronic apparatus controlling method of claim 1, further comprising:
displaying a function group icon on the touch control display, wherein the function group icon comprises the mapping cursor activating icon and a moving icon, wherein the function group icon is correspondingly moved while moving the moving icon.

10. The electronic apparatus controlling method of claim 1, wherein the step (a) further comprises:
displaying all buttons for an input interface in a region corresponding to the operation mapping region.

11. The electronic apparatus controlling method of claim 10, wherein the mapping cursor activating icon does not overlap the input interface while displaying both of the input interface and the mapping cursor activating icon.

12. The electronic apparatus controlling method of claim 1, further comprising:
displaying an operation mapping region cancelling icon, wherein the operation mapping region is cancelled if the operation mapping region cancelling icon is triggered.

13. The electronic apparatus controlling method of claim 12, wherein the operation mapping region cancelling icon is integrated to the mapping cursor activating icon.

14. The electronic apparatus controlling method of claim 1, wherein the operation mapping region is a range that fingers of a single hand can touch when the user holds the electronic apparatus with the single hand.

15. The electronic apparatus controlling method of claim 1, wherein the step (a) displays the mapping cursor activating icon while displaying a phone dialing interface, wherein the phone dialing interface comprises a numeral matrix, wherein the step (b) further comprises moving the mapping cursor to a numeral button of the button matrix via moving the mapping cursor activating icon, wherein the initial control operation in the step (c) is an initial tap operation, and the mapping control operation is a trigger operation for the numeral buttons.

16. The electronic apparatus controlling method of claim 1, wherein the step (a) displays the mapping cursor activating icon while displaying a map, wherein the step (b) further comprises moving the mapping cursor to a specific location of the map via moving the mapping cursor activating icon, wherein the initial control operation in the step (c) is a zoom in triggering operation or a zoom out triggering operation, wherein the mapping control operation is zooming in or zooming out the mapping cursor region corresponding to the mapping cursor.

17. The electronic apparatus controlling method of claim 16, wherein the step (c) comprises at least one of following steps to perform the zoom in operation or the zoom out operation:
displaying a zoom icon on the touch control display, and activating the zoom in triggering operation or the zoom out triggering operation if the zoom icon is triggered; and
performing a plurality of tapping operations on the operation mapping region to perform the zoom in triggering operation or the zoom out triggering operation.

18. The electronic apparatus controlling method of claim 1, wherein the step (a) displays the mapping cursor activating icon while displaying a map; wherein the step (c) further comprises: (c1) performing a dragging operation as the initial control operation, wherein the mapping control operation is moving a specific location of the map to the mapping cursor region corresponding to the mapping cursor; (c2) performing a zoom in triggering operation or a zoom out triggering operation as the initial control operation after the step (c1), and using an operation of zooming in or zooming out the mapping cursor region corresponding to the mapping cursor as the mapping control operation.

19. The electronic apparatus controlling method of claim 18, wherein the step (c2) comprises at least one of following steps to perform the zoom in operation or the zoom out operation:
displaying a zoom icon on the touch control display, and activating the zoom in triggering operation or the zoom out triggering operation if the zoom icon is triggered; and
performing a plurality of tapping operations on the operation mapping region to perform the zoom in triggering operation or the zoom out triggering operation.

20. The electronic apparatus controlling method of claim 1, wherein the step (a) displays the mapping cursor activating icon while displaying a social network software interface, wherein the step (b) moves the mapping cursor to a chatting icon via moving the mapping cursor activating icon, wherein the initial control operation in the step (c) is an initial tapping operation, wherein the mapping control operation is a mapping tapping operation to trigger the chatting icon to display a chatting interface.

21. The electronic apparatus controlling method of claim 1, wherein the step (a) displays the mapping cursor activating icon while displaying a website, wherein the step (b) moves the mapping cursor to a function icon via moving the mapping cursor activating icon, wherein the initial control operation in the step (c) is an initial tapping operation, wherein the mapping control operation is a mapping tapping operation to trigger a function corresponding to the function icon.
